(19) United States
(12) Patent Application Publication
(10) Pub. No.: US 2026/0360080 A1
(43) Pub. Date: Nov. 12, 2026

(54) METHOD FOR THREE-DIMENSIONAL RECONSTRUCTION OF TRAFFIC ACCIDENT SCENES COMBINING GROUND AND AERIAL PERSPECTIVES

(71) Applicants: China University of Geosciences, Wuhan (CN); Hubei Traffic Research Institute, Wuhan (CN); Wuhan Changjiang Communication Intelligent Link Technology Co., Ltd., Wuhan (CN)

(72) Inventors: Xiang Zhang, Wuhan (CN); Wenyi Lu, Wuhan (CN); Nengcheng Chen, Wuhan (CN); Bin Li, Wuhan (CN); Xihui Gu, Wuhan (CN); Ziqin Sang, Wuhan (CN); Wei Qi, Wuhan (CN); Zeqiang Chen, Wuhan (CN); Wenying Du, Wuhan (CN); Lihao Yang, Wuhan (CN); Qian Yu, Wuhan (CN)

(21) Appl. No.: 19/722,339

(22) Filed: Jun. 26, 2026

(30) Foreign Application Priority Data
Nov. 13, 2025 (CN) 202511659369.8

(51) Int. Cl. G06T 17/00; G06T 7/50; G06T 7/73; G06T 7/80; G06V 10/25; G06V 10/26; G06V 10/30; G06V 20/17; G06V 20/56

(52) U.S. Cl. CPC G06T 17/00; G06T 7/50; G06T 7/73; G06T 7/80; G06V 10/25; G06V 10/26; G06V 10/30; G06V 20/17; G06V 20/56; G06T 2200/08; G06T 2207/10032; G06T 2207/30252

(57) ABSTRACT

A method for three-dimensional reconstruction of traffic accident scenes combining ground and aerial perspectives includes: collecting images of a traffic accident scene by using cameras mounted on two platforms, namely an unmanned aerial vehicle (UAV) camera and an unmanned ground vehicle (UGV) camera, performing semantic segmentation on the images, and generating pixel-level masks of key targets; extracting regions of interest (ROIs) from the images according to the pixel-level masks of the key targets, and performing image enhancement and denoising processing on the ROIs to obtain processed ROI images; optimizing intrinsic and extrinsic parameters of the UAV camera and the UGV camera, performing absolute scale recovery, and reconstructing a three-dimensional surface model by using a Structure-from-Motion (SfM) method incorporating a joint camera optimization objective function, a Multi-View Stereo (MVS) method, and a surface reconstruction method; and performing digital quantitative analysis on the traffic accident scene through the three-dimensional surface model.

### CROSS REFERENCE TO RELATED APPLICATION

This patent application claims the benefit and priority of Chinese Patent Application No. 202511659369.8 filed with the China National Intellectual Property Administration on Nov. 13, 2025, the disclosure of which is incorporated by reference herein in its entirety as part of the present application.

### TECHNICAL FIELD

The present disclosure relates to the technical field of three-dimensional reconstruction, and in particular, to a method for three-dimensional reconstruction of traffic accident scenes combining ground and aerial perspectives.

### BACKGROUND

Visual three-dimensional reconstruction technology aims to automatically reconstruct three-dimensional geometric and texture information of a scene by analyzing multi-view images. In the field of traffic accident handling, this technology is of great significance for evidence preservation, liability determination, traffic restoration, and post-accident analysis of accident scenes.

Traditional accident scene investigation mainly relies on manual measurement and photography, which suffers from problems such as low efficiency, poor accuracy, high risk (especially in the case of hazardous material leakage), and incomplete information (with a large number of occlusions and blind spots). In recent years, unmanned aerial vehicle (UAV)-based aerial reconstruction using a single platform has been introduced. It can provide a macroscopic aerial view of the scene, but is incapable of capturing critical information such as vehicle underbodies, side collision details, and occluded evidence. Similarly, using only ground-based equipment (such as handheld cameras or unmanned ground vehicles (UGVs)) can capture local details but fails to grasp the overall situation of the accident scene and is difficult to associate with global coordinates. Both aerial and ground perspectives have inherent information blind spots. UAVs cannot effectively capture vehicle underbodies and vertical sides, while ground perspectives cannot obtain the overall distribution of roof deformations and scattered debris. Traditional methods cannot automatically identify and separate accident vehicles from the background environment, resulting in a large amount of irrelevant information contained in the reconstructed model and affecting the accuracy of subsequent analysis. During fusion of multi-platform data, the lack of an accurate joint camera calibration optimization algorithm leads to inconsistent scales and registration errors in the reconstructed model. The reconstructed model often lacks absolute scale references to the real world, making precise measurement analysis impossible. Accident scene investigation needs to be completed in the shortest possible time to restore traffic as soon as possible while ensuring safety of investigation personnel. Moreover, existing processes often struggle to balance efficiency, comprehensiveness, and safety.

### SUMMARY

An objective of the present disclosure is to provide a method for three-dimensional reconstruction of traffic accident scenes combining ground and aerial perspectives, so as to solve the problems of insufficient camera calibration optimization and lack of absolute scale information in existing three-dimensional reconstruction methods. The method includes the following steps:
S1: collecting images of a traffic accident scene by using cameras mounted on two platforms, namely an unmanned aerial vehicle (UAV) camera and an unmanned ground vehicle (UGV) camera, performing semantic segmentation on the images, and generating pixel-level masks of key targets;
S2: extracting regions of interest (ROIs) from the images according to the pixel-level masks of the key targets, and performing image enhancement and denoising processing on the ROIs to obtain processed ROI images;
S3: optimizing intrinsic and extrinsic parameters of the UAV camera and the UGV camera, performing absolute scale recovery, and based on the pixel-level masks of the key targets and the processed ROI images, reconstructing a three-dimensional surface model by using a Structure-from-Motion (SfM) method incorporating a joint camera optimization objective function, a Multi-View Stereo (MVS) method, and a surface reconstruction method; and
S4: performing digital quantitative analysis on the traffic accident scene through the three-dimensional surface model.

Further, the semantic segmentation of the images is performed using a segmentation network with a Segment Anything Model (SAM) architecture.

Further, the intrinsic parameter matrix of the UAV camera is K_{UAV}, and the intrinsic parameter matrix of the UGV camera is K_{UGV}, with expressions as follows:

$${K}_{U A V} = [ \begin{matrix}{f}_{x}^{U A V} & 0 & {c}_{x}^{U A V} \\ 0 & {f}_{y}^{U A V} & {c}_{y}^{U A V} \\ 0 & 0 & 1\end{matrix} ]$$

$${K}_{U G V} = [ \begin{matrix}{f}_{x}^{UGV} & 0 & {c}_{x}^{UGV} \\ 0 & {f}_{y}^{U G V} & {c}_{y}^{UGV} \\ 0 & 0 & 1\end{matrix} ]$$

where

$${f}_{x}^{U A V}$$

represents an x-axis value of an equivalent focal length of the UAV camera in pixel coordinates;

$${f}_{y}^{UAV}$$

represents a y-axis value of an equivalent focal length of the UAV camera in pixel coordinates;

$${c}_{x}^{U A V}$$

represents an x-axis value of an imaging center of the UAV camera;

$${c}_{y}^{U A V}$$

represents a y-axis value of the imaging center of the UAV camera;

$${f}_{x}^{U G V}$$

represents an x-axis value of an equivalent focal length of the UGV camera in pixel coordinates;

$${f}_{y}^{UGV}$$

represents a y-axis value of the equivalent focal length of the UGV camera in pixel coordinates;

$${c}_{x}^{UGV}$$

represents an x-axis value of an imaging center of the UGV camera; and

$${c}_{y}^{UGV}$$

represents a y-axis value of the imaging center of the UGV camera.

Further, a calculation formula of the joint camera optimization objective function is as follows:

$${E}_{total} ( θ ) = \underbrace{{\sum }_{i = 1}^{{N}_{UAV}} {\sum }_{j = 1}^{{M}_{i}} {‖ {x}_{ij}^{UAV} - π ( {K}_{UAV} , {R}_{i}^{UAV} , {t}_{i}^{UAV} , {X}_{j} ) ‖}^{2}}_{UAV pixel residual} + \underbrace{{\sum }_{k = 1}^{{N}_{UGV}} {\sum }_{ℓ = 1}^{{M}_{k}} {‖ {x}_{k ℓ}^{UGV} - π ( {K}_{UGV} , {R}_{k}^{UGV} , {t}_{k}^{UGV} , {X}_{ℓ} ) ‖}^{2}}_{UGV pixel residual} + {λ}_{1} \underbrace{{\sum }_{c = 1}^{{M}_{c}} {‖ {X}_{c}^{UAV} - {X}_{c}^{UGV} ‖}^{2}}_{Point correspondence constraint} + {λ}_{2} \underbrace{{\sum }_{( a , b ) ∈ D} {( ‖ {X}_{a} - {X}_{b} ‖ - {d}_{ab} )}^{2}}_{Scale constraint} + {λ}_{3} \underbrace{{\sum }_{( i , k ) ∈ P} ( {‖ {R}_{k}^{UGV} {R}_{rel} - {R}_{i}^{UAV} ‖}_{F}^{2} + {‖ {t}_{k}^{UGV} + {R}_{k}^{UGV} {t}_{rel} - {t}_{i}^{UAV} ‖}^{2} )}_{Geometric consistency constraint} .$$

where

$$θ = \{ {K}_{UAV} , {K}_{UGV} , {\{ {R}_{i}^{UAV} , {t}_{i}^{UAV} \}}_{i = 1}^{{N}_{UAV}} , {\{ {R}_{k}^{UGV} , {t}_{k}^{UGV} \}}_{k = 1}^{{N}_{UGV}} , {\{ {X}_{j} \}}_{j = 1}^{M} \}$$

represents optimized parameters; M represents a total number of three-dimensional points; K_{UAV} represents an intrinsic parameter matrix of the UAV camera; K_{UGV} represents an intrinsic parameter matrix of the UGV camera;

$${R}_{i}^{UAV}$$

represents a UAV camera rotation matrix corresponding to an i-th UAV image;

$${t}_{i}^{UAV}$$

represents a UAV camera translation vector corresponding to the i-th UAV image;

$${R}_{k}^{UGV}$$

represents a UGV camera rotation matrix corresponding to a k-th UGV image;

$${t}_{k}^{UGV}$$

represents a UGV camera translation vector corresponding to the k-th UGV image; N_{UAV} represents a number of UAV images/poses involved in optimization; Mᵢ represents a number of effective observation points in the i-th UAV image;

$${x}_{ij}^{UAV}$$

represents a pixel observation of a j-th point in the i-th UAV image; Xⱼ represents a position of a j-th three-dimensional point in a world coordinate system, and three-dimensional point coordinates are obtained from co-visual pixel points of a plurality of two-dimensional images; N_{UGV} represents a number of UGV images/poses involved in optimization; Mₖ represents a number of effective observation points in the k-th UGV image;

$${x}_{k ℓ}^{UGV}$$

represents a pixel observation of an l-th point in the k-th UGV image; [symbol] represents a position of an [symbol] -th three-dimensional point in the world coordinate system; λ₁, λ₂, and λ₃ represent weights of a point correspondence constraint, a scale constraint, and a geometric consistency constraint, respectively; M_{c} represents a number of co-visual point correspondences between the two platforms;

$${X}_{c}^{UAV}$$

represents a pixel observation of a c-th point correspondence in a UAV image;

$${x}_{c}^{UGV}$$

represents a pixel observation of the c-th point correspondence in a UGV image; Xₐ represents a position of an a-th three-dimensional point in a distance prior; X_{b} represents a position of a b-th three-dimensional point in the distance prior; d_{ab} represents a known physical distance between point Xₐ and point X_{b}; (a,b)∈ [symbol] represents an index set of point pairs having known physical distances; Rᵣₑₗ represents a relative rotation between the two cameras; tᵣₑₗ represents a relative translation between the two cameras; (i,k)∈ [symbol] represents a set of UAV/UGV pose pairs for the geometric consistency constraint; and π represents a camera projection function.

Further, a method for the absolute scale recovery is as follows:
conducting distance measurement by using a depth camera carried on the UGV; arranging a calibration board of known dimensions within a visible range of the UAV; and establishing a scale ratio relationship:

$${S}_{absolute} = \frac{{D}_{real}}{{D}_{reconstructed}} = \frac{‖ {P}_{1}^{real} - {P}_{2}^{real} ‖}{‖ {P}_{1}^{r econ} - {P}_{2}^{r econ} ‖}$$

where S_{absolute} represents a scale ratio for scaling a reconstructed model from reconstruction units to real meters; Dᵣₑₐₗ represents a real distance measured by the depth camera; D_{reconstructed} represents a relative distance in the reconstructed model;

$${P}_{1}^{real}$$

represents three-dimensional coordinates of a first point in real space;

$${P}_{2}^{real}$$

represents three-dimensional coordinates of a second point in real space;

$${P}_{1}^{r econ}$$

represents three-dimensional coordinates in the reconstructed model corresponding to

$${P}_{1}^{real} ; and {P}_{1}^{r econ}$$

represents three-dimensional coordinates in the reconstructed model corresponding to

$${P}_{2}^{real} .$$

The present disclosure further provides a system for three-dimensional reconstruction of traffic accident scenes combining ground and aerial perspectives, including:
a semantic segmentation module configured to collect images of a traffic accident scene by using cameras mounted on two platforms, namely an unmanned aerial vehicle (UAV) camera and an unmanned ground vehicle (UGV) camera, perform semantic segmentation on the images, and generate pixel-level masks of key targets;
a region of interest (ROI) image acquisition module configured to extract ROIs from the images according to the pixel-level masks of the key targets, and perform image enhancement and denoising processing on the ROIs to obtain processed ROI images;
a three-dimensional reconstruction module configured to optimize intrinsic and extrinsic parameters of the UAV camera and the UGV camera, perform absolute scale recovery, and based on the pixel-level masks of the key targets and the processed ROI images, reconstruct a three-dimensional surface model by using a Structure-from-Motion (SfM) method incorporating a joint camera optimization objective function, a Multi-View Stereo (MVS) method, and a surface reconstruction method; and
an accident scene analysis module configured to perform digital quantitative analysis on the traffic accident scene through the three-dimensional surface model.

The present disclosure further provides a computer-readable storage medium, storing a computer program, where when executed by a processor, the computer program implements the method for three-dimensional reconstruction of traffic accident scenes combining ground and aerial perspectives.

The present disclosure further provides an electronic device, including a processor and a memory, where the processor and the memory are connected to each other, the memory is configured to store a computer program that includes a computer-readable instruction, and the processor is configured to invoke the computer-readable instruction to execute the method for three-dimensional reconstruction of traffic accident scenes combining ground and aerial perspectives.

The present disclosure further provides a computer program product, including a computer program/instruction, where when executed by a processor, the computer program/instruction implements steps of the method for three-dimensional reconstruction of traffic accident scenes combining ground and aerial perspectives.

The technical solutions provided by the present disclosure have the following beneficial effects:

The present disclosure combines the macroscopic perspective of UAVs with the microscopic perspective of UGVs, effectively eliminating the observation blind spots of a single perspective and achieving full coverage of the accident scene. A Structure-from-Motion (SfM) method incorporating a joint camera optimization objective function, a Multi-View Stereo (MVS) method, and a surface reconstruction method are employed to reconstruct a three-dimensional surface model, thereby achieving high-precision fusion of multi-view data from UAVs and UGVs, and ensuring intrinsic and extrinsic parameter consistency of the reconstructed model. An absolute scale guarantee is provided by a dual constraint mechanism using a depth camera and a high-precision calibration board. Scale calibration assisted by depth information, combined with geometric correction of the calibration board, ensures that the three-dimensional reconstruction result possesses absolute scales of the real world. The present disclosure solves the problems of insufficient camera calibration optimization and lack of absolute scale information in existing three-dimensional reconstruction methods.

### BRIEF DESCRIPTION OF THE DRAWINGS

FIG. 1 is a flowchart of a method for three-dimensional reconstruction of traffic accident scenes combining ground and aerial perspectives according to an embodiment of the present disclosure;

FIG. 2 is a schematic diagram of UAV-UGV-combined orbital aerial photography planning according to an embodiment of the present disclosure;

FIG. 3 is a schematic diagram of UAV vertical aerial photography altitude and UGV horizontal shooting planning according to an embodiment of the present disclosure;

FIG. 4 is a schematic diagram of UAV aerial photography angle and UGV shooting distance planning according to an embodiment of the present disclosure;

FIG. 5 is a schematic diagram of a sparse reconstruction result of a tanker truck head according to an embodiment of the present disclosure;

FIG. 6 is a schematic diagram of a high-precision dense three-dimensional model of a tanker truck head according to an embodiment of the present disclosure;

FIG. 7 illustrates a quantitative analysis result of a tanker truck head according to an embodiment of the present disclosure; and

FIG. 8 is a block diagram of an electronic device according to an exemplary embodiment of the present disclosure.

### DETAILED DESCRIPTION OF THE EMBODIMENTS

In order to make the objective, technical solution and advantages of the present disclosure clearer, embodiments of the present disclosure will be further described in detail in conjunction with the accompanying drawings.

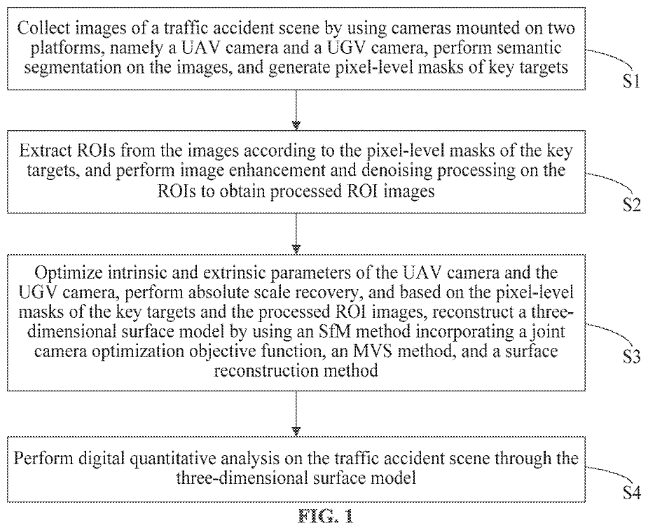

A flowchart of a method for three-dimensional reconstruction of traffic accident scenes combining ground and aerial perspectives according to an embodiment of the present disclosure is shown in FIG. 1, specifically including the following steps:
S1. Perform multi-platform collaborative deployment at a traffic accident scene, including deploying a UAV and a UGV, and placing a calibration object for scale recovery. Specifically, the UAV typically performs orbital flight to acquire a global overhead view and multi-angle oblique images of the accident scene from the air, so as to grasp the macroscopic layout and overall situation of the scene. The UGV approaches the accident vehicle and key evidence on the ground, focusing on capturing areas that cannot be effectively covered by the UAV perspective, such as vehicle underbodies, side collision details, and tire tracks, to make up for observation blind spots of the macroscopic perspective. An absolute scale calibration board is placed at the scene, with its physical dimensions precisely known in advance.

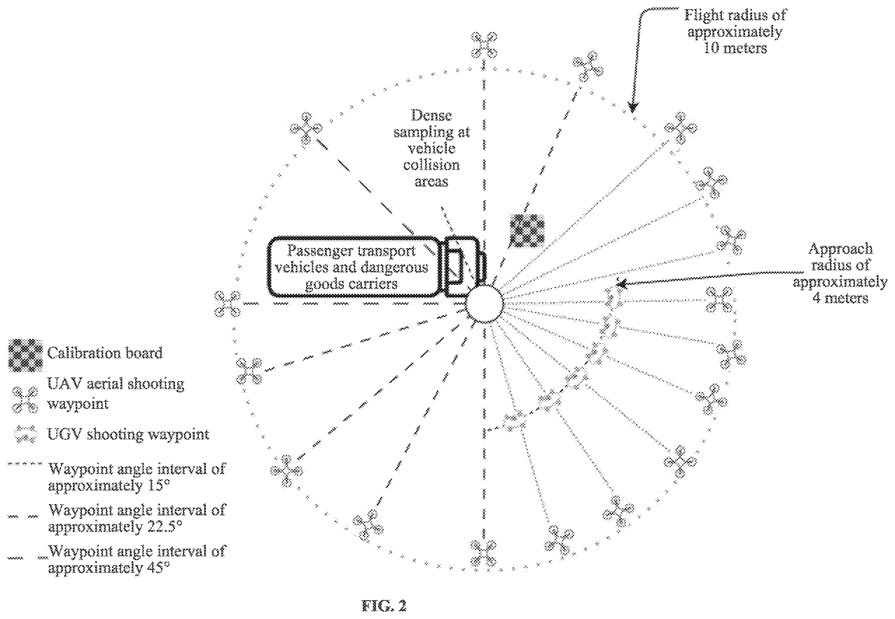

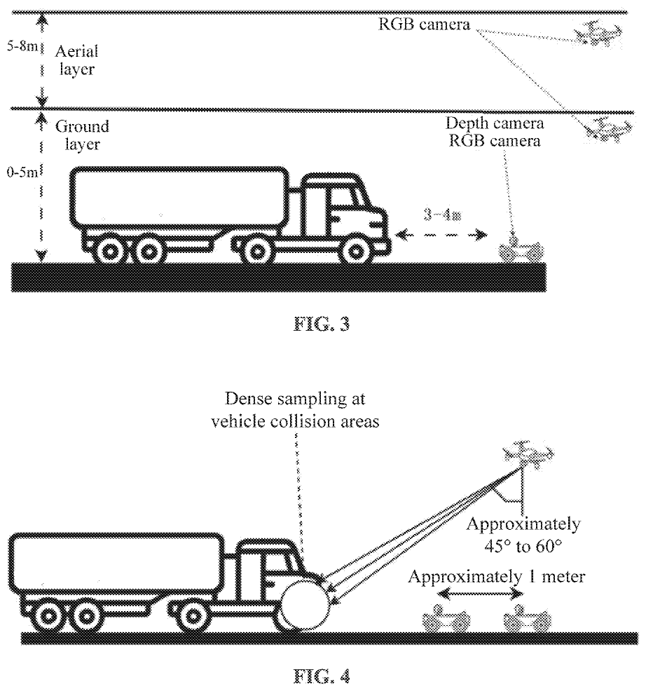

Referring to FIG. 2, FIG. 3, and FIG. 4, FIG. 2 is a schematic diagram of UAV-UGV-combined orbital aerial photography planning according to an embodiment of the present disclosure; FIG. 3 is a schematic diagram of UAV vertical aerial photography altitude and UGV horizontal shooting planning according to an embodiment of the present disclosure; FIG. 4 is a schematic diagram of UAV aerial photography angle and UGV shooting distance planning according to an embodiment of the present disclosure. (1) UAV aerial data acquisition settings: First, a UAV acquisition path is divided into a conventional orbital path and a layered aerial photography path. In the conventional orbital path, as shown in FIG. 2, the UAV flies along an orbital path centered on the accident vehicle. Preferably, a flight radius is approximately 10 to 12 meters, and a waypoint angle interval for one flight circle can be set to approximately 15°, 22.5°, or 45°. The UAV can hover at each waypoint for 2 to 5 seconds, and an onboard RGB camera of the UAV captures the accident vehicle at different pitch angles. Preferably, one or more pitch angles, such as approximately 45°, 50°, 55°, and 60°, can be used for shooting at one or more waypoints to obtain vehicle facade information from different angles. Particularly, for key areas of vehicle collision damage, dense sampling can be performed, that is, increasing the waypoint density or the number of pitch angles. In addition, as shown in FIG. 3, the UAV performs layered aerial photography targeting the entire tanker truck accident scene. Preferably, two altitude levels can be used: an “aerial layer” at an altitude of approximately 5 to 8 meters and a “ground layer” at an altitude of approximately 0 to 5 meters. Image data from the “aerial layer” is mainly used to reflect the macroscopic layout and overall situation of the scene; image data from the “ground layer” is used to more clearly reflect details of the upper part of the vehicle and surrounding scattered debris. (2) UGV ground data acquisition settings: Simultaneously with or after the UAV aerial data acquisition, as shown in FIG. 2, a UGV equipped with an RGB camera and a depth camera is deployed to start shooting at an approach radius of approximately 3 to 4 meters. As shown in FIG. 3, the UGV performs close-range shooting at the “ground layer”, primarily responsible for capturing areas with occlusions and blind spots from the UAV perspective, such as vehicle sides, underbodies, and low-angle collision details. (3) Ground-aerial joint dense sampling settings for key areas: For key collision damage locations on large vehicles including passenger transport vehicles and dangerous goods carriers, to obtain the most comprehensive detail data, a ground-aerial joint dense sampling strategy is adopted, as shown in FIG. 4. At this time, the UAV can perform supplementary targeted shooting of the damaged area at different altitude layers with different camera pitch angles with an angle difference of approximately 5° to 10°. Meanwhile, the UGV can move forward for an additional 1 meter to conduct detailed shooting at a closer distance to the damaged positions. This aerial-ground collaboration that combines close-range and long-range observations with multi-angle complementation ensures occlusion-free acquisition of all key evidence information.

The UAV and UGV deployed in multi-platform collaboration perform data acquisition tasks at the scene and transmit the acquired image data in real time to an on-site computing unit. The computing unit performs semantic segmentation on the images by using a deep learning model to generate pixel-level masks of key targets. Specifically, in the process of generating key target masks through deep learning-based semantic segmentation, collected RGB images are input into a pre-trained segmentation network, such as a segmentation network based on a Segment Anything Model (SAM) architecture. The segmentation network automatically identifies and precisely segments targets crucial for accident analysis, such as accident vehicles, road markings, and key scattered debris, and generates an independent pixel-level binary mask for each target.
S2. Extract regions of interest (ROIs) from the images according to the pixel-level masks of the key targets, perform image enhancement and denoising processing on the ROIs, establish a target-image correspondence, and obtain processed ROI images. This step focuses the reconstruction on valid targets, which greatly suppresses interference from irrelevant information such as background environments and provides high-quality ROIs for subsequent feature point extraction and matching, thereby significantly improving reconstruction accuracy and efficiency.
S3. Optimize intrinsic and extrinsic parameters of the UAV camera and the UGV camera, perform absolute scale recovery, and based on the pixel-level masks of the key targets and the processed ROI images, reconstruct a three-dimensional surface model by using a Structure-from-Motion (SfM) method incorporating a joint camera optimization objective function, a Multi-View Stereo (MVS) method, and a surface reconstruction method.
   Specific steps are as follows:

The intrinsic parameter matrix of the UAV camera is K_{UAV}, and the intrinsic parameter matrix of the UGV camera is K_{UGV}, with expressions as follows:

$${K}_{UAV} = [ \begin{matrix}{f}_{x}^{UAV} & 0 & {c}_{x}^{UAV} \\ 0 & {f}_{y}^{UAV} & {c}_{y}^{UAV} \\ 0 & 0 & 1\end{matrix} ]$$

$${K}_{UGV} = [ \begin{matrix}{f}_{x}^{UGV} & 0 & {c}_{x}^{UGV} \\ 0 & {f}_{y}^{UGV} & {c}_{y}^{UGV} \\ 0 & 0 & 1\end{matrix} ]$$

where

$${f}_{x}^{UAV}$$

represents an x-axis value of an equivalent focal length of the UAV camera in pixel coordinates;

$${f}_{y}^{UAV}$$

represents a y-axis value of an equivalent focal length of the UAV camera in pixel coordinates;

$${C}_{x}^{UAV}$$

represents an x-axis value of an imaging center of the UAV camera;

$${C}_{y}^{UAV}$$

represents a y-axis value of the imaging center of the UAV camera;

$${f}_{x}^{UGV}$$

represents an x-axis value of an equivalent focal length of the UGV camera in pixel coordinates;

$${f}_{y}^{UGV}$$

represents a y-axis value of the equivalent focal length of the UGV camera in pixel coordinates;

$${C}_{x}^{UGV}$$

represents an x-axis value of an imaging center of the UGV camera; and

$${C}_{y}^{UGV}$$

represents a y-axis value of the imaging center of the UGV camera.

Since the cameras mounted on both the UAV and the UGV platforms adopt square pixels and non-skewed readout, the skew coefficient is set to 0. If single-camera calibration results are already available, such results can be directly used; otherwise, heuristic initial values can be provided through a checkerboard method or by using the image resolution center and diagonal pixel count to ensure convergence of subsequent optimization.

In a preferred embodiment of the present disclosure, a joint camera optimization objective function is constructed to optimize the camera intrinsic parameters K_{UAV} and K_{UGV}, extrinsic parameters

$$\{ {R}_{i}^{UAV} , {t}_{i}^{UAV} \} and \{ {R}_{k}^{UGV} , {t}_{k}^{UGV} \} ,$$

and three-dimensional point coordinates of the UAV and UGV platforms, unifying the intrinsic and extrinsic camera parameters of the two platforms. A least squares problem with minimized total residuals is defined, where the constraint terms include a point correspondence constraint, a scale constraint, and a geometric consistency constraint, and the calculation formula is as follows:

$${E}_{total} ( θ ) = {\underbrace{{\sum }_{i = 1}^{{N}_{UAV}} {\sum }_{j = 1}^{{M}_{i}} {‖ {x}_{ij}^{UAV} - π ( {P}_{UAV} , {R}_{i}^{UAV} , {t}_{i}^{UAV} , {X}_{j} ) ‖}^{2}}}_{UAV pixel residual} + {\underbrace{{\sum }_{k = 1}^{{N}_{UAV}} {\sum }_{ℓ = 1}^{{M}_{k}} {‖ {x}_{k ℓ}^{UGV} - π ( {K}_{UGV} , {R}_{k}^{UGV} , {t}_{k}^{UGV} , {X}_{ℓ} ) ‖}^{2}}}_{UGV pixel residual} + {λ}_{1} {\underbrace{{\sum }_{j = 1}^{{M}_{c}} {‖ {X}_{c}^{UAV} - {X}_{c}^{UGV} ‖}^{2}}}_{Point correspondence constraint} + {λ}_{2} {\underbrace{{\sum }_{( a , b ) ∈ 𝒟} {( ‖ {X}_{a} - {X}_{b} ‖ - {d}_{ab} )}^{2}}}_{Scale constraint} + {λ}_{3} {\underbrace{{\sum }_{( i , k ) ∈ 𝒫} ( {‖ {R}_{k}^{UGV} {R}_{rel} - {R}_{i}^{UAV} ‖}_{F}^{2} + {‖ {t}_{k}^{UGV} + {R}_{k}^{UGV} {t}_{rel} - {t}_{i}^{UAV} ‖}^{2} )}}_{Geometric consistency constraint} .$$

where

$$θ = \{ {K}_{UAV} , {K}_{UGV} , {\{ {R}_{i}^{UAV} , {t}_{i}^{UAV} \}}_{i = 1}^{{N}_{UAV}} , {\{ {R}_{k}^{UGV} , {t}_{k}^{UGV} \}}_{k = 1}^{{N}_{UGV}} , {\{ {X}_{j} \}}_{j = 1}^{M} \}$$

represents optimized parameters; M represents a total number of three-dimensional points; K_{UAV} represents an intrinsic parameter matrix of the UAV camera; K_{UGV} represents an intrinsic parameter matrix of the UGV camera;

$${R}_{i}^{UAV}$$

represents a UAV camera rotation matrix corresponding to an i-th UAV image, where a camera rotation matrix refers to rotation transformation of an image by different angles around different coordinate axes for mapping from a world coordinate system to a camera coordinate system;

$${t}_{i}^{UAV}$$

represents a UAV camera translation vector corresponding to the i-th UAV image, where a camera translation vector refers to translation transformation of an image for mapping from the world coordinate system to the camera coordinate system;

$${R}_{k}^{UGV}$$

represents a UGV camera rotation matrix corresponding to a k-th UGV image;

$${t}_{k}^{UGV}$$

represents a UGV camera translation vector corresponding to the k-th UGV image; N_{UAV} represents a number of UAV images/poses involved in optimization; Mᵢ represents a number of effective observation points in the i-th UAV image;

$${x}_{ij}^{UAV}$$

represents a pixel observation of a j-th point in the i-th UAV image; represents a position of a j-th three-dimensional point in the world coordinate system, and three-dimensional point coordinates are obtained from co-visual pixel points of a plurality of two-dimensional images; N_{UGV} represents a number of UGV images/poses involved in optimization; Mₖ represents a number of effective observation points in the k-th UGV image;

$${x}_{kℓ}^{UGV}$$

represents a pixel observation of an [symbol] -th point in the k-th UGV image; [symbol] represents a position of an e-th three-dimensional point in the world coordinate system; λ₁, λ₂, and λ₃ represent weights of a point correspondence constraint, a scale constraint, and a geometric consistency constraint, respectively; M_{c} represents a number of co-visual point correspondences between the two platforms;

$${X}_{c}^{UAV}$$

represents a pixel observation of a c-th point correspondence in a UAV image;

$${X}_{c}^{UGV}$$

represents a pixel observation of a c-th point correspondence in a UAV image; Xₐ represents a position of an a-th three-dimensional point in a distance prior; X_{b} represents a position of a b-th three-dimensional point in the distance prior; d_{ab} represents a known physical distance between point Xₐ and point X_{b}; (a,b)∈ [symbol] represents an index set of point pairs having known physical distances; Rᵣₑₗ represents a relative rotation between the two cameras (UGV→UAV); tᵣₑₗ represents a relative translation between the two cameras (UGV→UAV); (i,k)∈ [symbol] represents a set of UAV/UGV pose pairs for the geometric consistency constraint; and π represents a camera projection function (R³→R²).

The least squares problem can be iteratively solved using sparse Levenberg-Marquardt (LM) method of the Ceres Solver. The solution strategy is as follows: First, all parameters of K, R, T are initialized with single-camera calibration or heuristic results. Then, sparse LM is adopted to iteratively minimize Eₜₒₜₐₗ(θ) During the iteration, the damping factor is automatically adjusted until the pixel reprojection error and the constraint residuals converge simultaneously. By introducing three types of prior terms, i.e., point correspondence, scale, and geometric constraints, in addition to camera reprojection errors, joint optimization can complete cross-platform calibration, scale alignment, and pose refinement at the same time, thereby laying a geometrically consistent foundation for subsequent multi-source fusion. Bundle adjustment (BA) is performed on image feature points, camera intrinsic/extrinsic parameters, and scale constraint information from the UAV and UGV, to minimize reprojection errors of all viewing angles, thereby achieving perfect spatial and scale alignment between the two heterogeneous platforms.

Next, a sparse three-dimensional point cloud with absolute scale information is generated through an SfM process based on the joint camera optimization objective function. The absolute scale recovery is implemented as follows:
conducting distance measurement by using a depth camera carried on the UGV; arranging a calibration board of known dimensions within a visible range of the UAV; and establishing a scale ratio relationship:

$${S}_{absolute} = \frac{{D}_{real}}{{D}_{reconstructed}} = \frac{‖ {P}_{1}^{real} - {P}_{2}^{real} ‖}{‖ {P}_{1}^{recon} - {P}_{2}^{recon} ‖}$$

where S_{absolute} represents a scale ratio for scaling a reconstructed model from reconstruction units to real meters; Dᵣₑₐₗ represents a real distance measured by the depth camera; D_{reconstructed} represents a relative distance in the reconstructed model;

$${P}_{1}^{real}$$

represents three-dimensional coordinates of a first point in real space;

$${P}_{2}^{real}$$

represents three-dimensional coordinates of a second point in real space;

$${P}_{1}^{recon}$$

represents three-dimensional coordinates in the reconstructed model corresponding to

$${P}_{1}^{real} ; and {P}_{2}^{recon}$$

represents three-dimensional coordinates in the reconstructed model corresponding to

$${P}_{2}^{real} .$$

Finally, through a generalized stereo reconstruction process, the sparse point cloud is densified to generate a high-precision three-dimensional surface model. The stereo reconstruction process is as follows: First, feature point matching is performed on the entire image library (including UAV and UGV images). Feature matching supports various feature description operators, including but not limited to Scale-Invariant Feature Transform (SIFT), Speeded Up Robust Features (SURF), Oriented FAST and Rotated BRIEF (ORB), and SuperPoint. Geometric constraints are adopted to filter mismatches by using mature solutions including but not limited to Random Sample Consensus (RANSAC) and variants thereof. The key is to successfully match point correspondences between UAV images and UGV images, while performing effective feature filtering based on target masks. The incremental sparse reconstruction is designed as a generalized SfM architecture, which can use solutions including but not limited to Open Multiple View Geometry (OpenMVG), COLMAP, and Visual Structure-from-Motion (VisualSfM), and is provided a unified input/output interface.

The subsequent stereo reconstruction process is designed as a generalized MVS reconstruction architecture. After the sparse three-dimensional structure is obtained, mature solutions including but not limited to Patch-based Multi-View Stereo (PMVS), Open Multi-View Stereo (OpenMVS), and Multi-View Environment (MVE) can be used to generate a dense three-dimensional structure. A comprehensive quality control and optimization mechanism is established. This mechanism includes dense reconstruction quality assessment based on target masks, multi-scale geometric consistency checking, and an adaptive parameter adjustment strategy. A variety of surface reconstruction methods are supported, including but not limited to Poisson reconstruction and Delaunay triangulation. Multiple texture mapping techniques are supported, and mature solutions including but not limited to multi-view texture fusion, seam elimination optimization, and texture atlas generation can be applied. This design ensures that even when processing complex scenes and heterogeneous data, rigorous geometric filtering and surface optimization can be adopted to ultimately generate a complete, accurate three-dimensional model with high-fidelity textures.
S4. Perform digital quantitative analysis on the traffic accident scene through the three-dimensional surface model. For example, non-contact precise measurement is performed on vehicle damage length, distribution range of scattered debris, and collision conditions. Finally, based on the analysis results, a digital investigation report for accident liability determination and post-accident analysis is output. Specifically, the generated final model is a measurable digital reproduction of the accident scene with a 1:1 ratio to the real world. Rescue personnel or accident analysis experts can observe the model from any angle and perform non-contact precision measurements in a safe office environment by using a backend analysis module and software including but not limited to MeshLab and CloudCompare. For example, the vehicle deformation degree, the size of the collision contact surface, and the positions of scattered debris relative to the vehicle can be precisely measured, all of which are difficult to obtain quickly and accurately using traditional investigation methods.

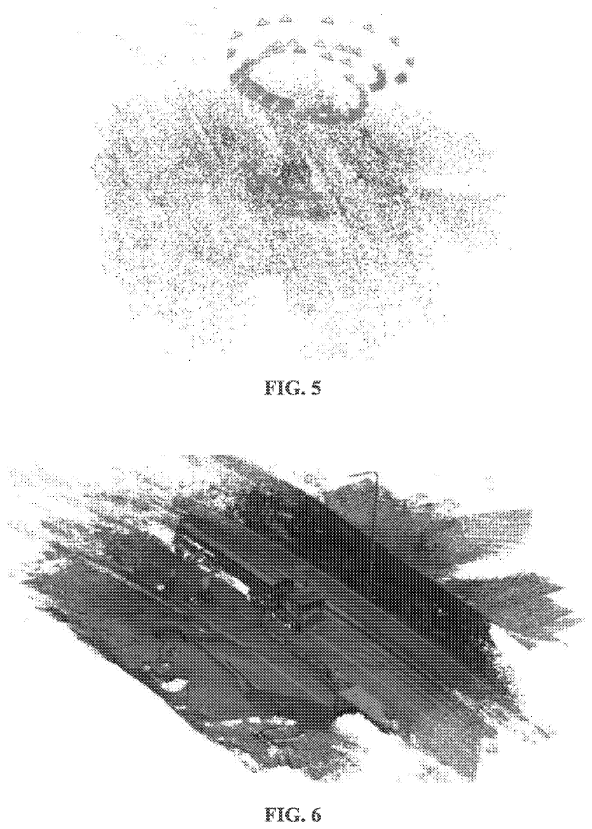

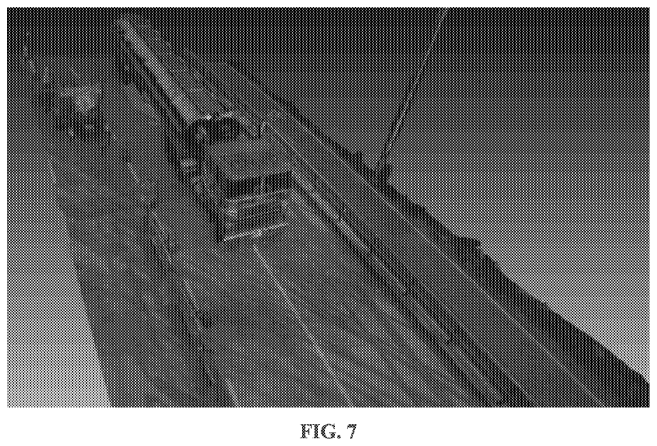

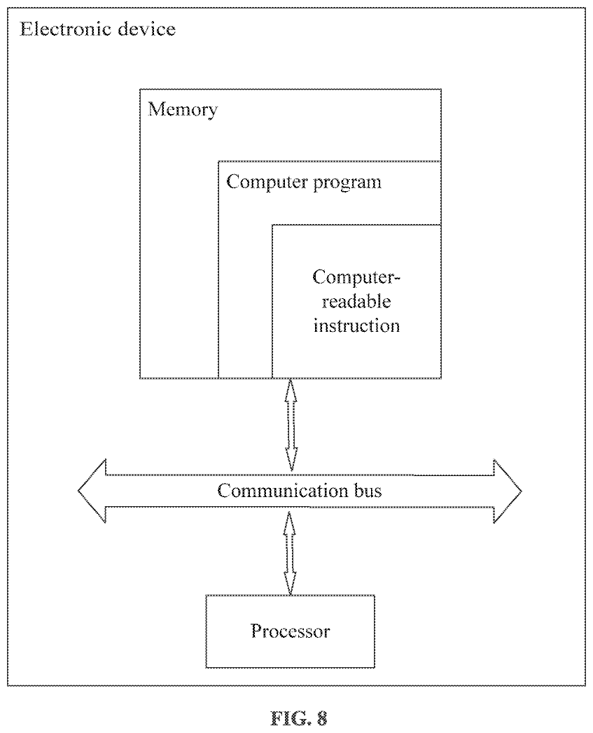

More specifically, taking a traffic accident caused by a rear-end collision of a tanker truck at a highway intersection as an example, the accident caused severe damage to the head of the tanker truck. A UAV, a UGV, and a calibration object are deployed at the scene. After preliminary identification of the accident scene and the vehicle, high-precision three-dimensional reconstruction is required for key parts of the vehicle head. The three-dimensional reconstruction steps for the traffic accident scene combining ground and aerial perspectives of the UGV and UAV according to the present disclosure are as follows:
(1) Data collection: First, a quadcopter UAV is controlled to fly orbitally around the damaged head of the accident tanker truck. The flight radius is set to approximately 10 meters, and flights are performed at two altitude levels of 5 meters and 8 meters. At each level, 16 main waypoints are set around the vehicle head, with an angle interval between waypoints ranging from 22.5° to 45°. At each waypoint, the onboard camera captures photos at a pitch angle of approximately 45°, acquiring a total of 32 images. Dense sampling is performed for the most severely damaged area at the vehicle head, yielding 31 additional images. A total of 63 UAV aerial images are acquired in this process. Meanwhile, a Mecanum wheel UGV is deployed to orbit at an approach radius of approximately 4 meters away from the side of the tanker truck head. The RGB camera and depth camera equipped on the UGV continuously shoot details of the damaged vehicle head, tires and chassis at an interval of 20°, and a total of 8 close-range images captured by the UGV are obtained.
(2) Reconstruction and result display: A total of 71 collected images (63 UAV images and 8 UGV images) are preprocessed and input into the reconstruction system of the present disclosure. After the joint calibration and optimization process and the sparse reconstruction process, a sparse reconstruction result of the tanker truck head as shown in FIG. 5 is obtained. Presented in COLMAP, this result clearly shows the camera poses of the 71 images involved in the reconstruction (including the layered orbital UAV camera poses in the air and the linear orbital UGV camera poses on the ground) and the sparse three-dimensional point cloud structure of the accident tanker truck head and the surrounding environment formed by matched feature points. This figure intuitively verifies the effectiveness and high precision of the aerial-ground data fusion of the present disclosure. Subsequently, after the densification reconstruction process, a high-precision three-dimensional model of the accident tanker truck head and the surrounding environment is ultimately generated, which can be a file in a standard format such as Polygon File Format (PLY). Refer to FIG. 6, which is a schematic diagram of a high-precision dense three-dimensional model of the tanker truck head.
(3) Quantitative analysis demonstration: As shown in FIG. 7, FIG. 7 illustrates the quantitative analysis result of the tanker truck head. The “Pick Point Measure” function of MeshLab can be used to directly select extreme points on both sides of the vehicle head on the three-dimensional point cloud to obtain a spatial distance of the vehicle head width. By performing three independent measurements on the same large tanker tractor, an average width from single readings is approximately 2.94 meters, while an actual measured value is 3.00 meters, with an absolute error controlled at about 6 cm. The results verify the practicability of the model in traffic accident reconstruction. Without additional measuring scales, the absolute dimensional accuracy within 10 centimeters and the relative error accuracy within 5% can be realized for large vehicles such as passenger transport vehicles and dangerous goods carriers.

In an exemplary embodiment, a system for three-dimensional reconstruction of traffic accident scenes combining ground and aerial perspectives is provided, including:
a semantic segmentation module configured to collect images of a traffic accident scene by using cameras mounted on two platforms, namely a UAV camera and a UGV camera, perform semantic segmentation on the images, and generate pixel-level masks of key targets;
an ROI image acquisition module configured to extract ROIs from the images according to the pixel-level masks of the key targets, and perform image enhancement and denoising processing on the ROIs to obtain processed ROI images;
a three-dimensional reconstruction module configured to optimize intrinsic and extrinsic parameters of the UAV camera and the UGV camera, perform absolute scale recovery, and based on the pixel-level masks of the key targets and the processed ROI images, reconstruct a three-dimensional surface model by using an SfM method incorporating a joint camera optimization objective function, an MVS method, and a surface reconstruction method; and
an accident scene analysis module configured to perform digital quantitative analysis on the traffic accident scene through the three-dimensional surface model.

In an exemplary embodiment, a computer-readable storage medium is provided. The computer-readable storage medium stores a computer program. When executed by a processor, the computer program implements the method for three-dimensional reconstruction of traffic accident scenes combining ground and aerial perspectives.

Referring to FIG. 8, in an exemplary embodiment, an electronic device is further provided, including at least one processor, at least one memory, and at least one communication bus.

The memory stores a computer program, the computer program includes a computer-readable instruction, and the processor invokes, through the communication bus, the computer-readable instruction stored in the memory, to execute the method for three-dimensional reconstruction of traffic accident scenes combining ground and aerial perspectives.

In an exemplary embodiment, a computer program product is provided, including a computer program/instruction. When executed by a processor, the computer program/instruction implements steps of the method for three-dimensional reconstruction of traffic accident scenes combining ground and aerial perspectives.

The above description of the disclosed embodiments enables those skilled in the art to achieve or use the present disclosure. Various modifications to these embodiments are readily apparent to those skilled in the art, and the general principles defined herein may be practiced in other embodiments without departing from the spirit or scope of the present disclosure. Thus, the present disclosure is not limited to the embodiments shown herein but falls within the widest scope consistent with the principles and novel features disclosed herein.

What is claimed is:

1. A method for three-dimensional reconstruction of traffic accident scenes combining ground and aerial perspectives, comprising following steps:
S1: collecting images of a traffic accident scene by using cameras mounted on two platforms, namely an unmanned aerial vehicle (UAV) camera and an unmanned ground vehicle (UGV) camera, performing semantic segmentation on the images, and generating pixel-level masks of key targets;
S2: extracting regions of interest (ROIs) from the images according to the pixel-level masks of the key targets, and performing image enhancement and denoising processing on the ROIs to obtain processed ROI images;
S3: optimizing intrinsic and extrinsic parameters of the UAV camera and the UGV camera, performing absolute scale recovery, and based on the pixel-level masks of the key targets and the processed ROI images, reconstructing a three-dimensional surface model by using a Structure-from-Motion (SfM) method incorporating a joint camera optimization objective function, a Multi-View Stereo (MVS) method, and a surface reconstruction method; and
S4: performing digital quantitative analysis on the traffic accident scene through the three-dimensional surface model;
wherein a calculation formula of the joint camera optimization objective function is as follows:
$${E}_{total} ( θ ) = {\underbrace{\begin{matrix}{\sum }_{i = 1}^{{N}_{UAV}} {\sum }_{j = 1}^{{M}_{i}} & {‖ {x}_{ij}^{UAV} - π ( {K}_{UAV} , {R}_{i}^{UAV} , {t}_{i}^{UAV} , {X}_{j} ) ‖}^{2}\end{matrix}}}_{UAV pixel residual} + {\underbrace{\begin{matrix}{\sum }_{k = 1}^{{N}_{UGV}} {\sum }_{ℓ = 1}^{{M}_{k}} & {‖ {x}_{kℓ}^{UGV} - π ( {K}_{UGV} , {R}_{k}^{UGV} , {t}_{k}^{UGV} , {X}_{ℓ} ) ‖}^{2}\end{matrix}}}_{UGV pixel residual} + {{λ}_{1} \underbrace{\begin{matrix}{\sum }_{c = 1}^{{M}_{c}} & {‖ {X}_{c}^{UAV} - {X}_{c}^{UGV} ‖}^{2}\end{matrix}}}_{Point correspondence constraint} + {λ}^{2} {\underbrace{\begin{matrix}{\sum }_{( a , b ) ∈ 𝒟} {( ‖ {X}_{a} - {X}_{b} ‖ - {d}_{ab} )}^{2} & \end{matrix}}}_{Scale constraint} + {λ}_{3} {\underbrace{\begin{matrix}{\sum }_{( i , k ) ∈ 𝒫} ( {‖ {R}_{k}^{UGV} {R}_{rel} - {R}_{i}^{UAV} ‖}_{F}^{2} + {‖ {t}_{k}^{UGV} + {R}_{k}^{UGV} {t}_{rel} - {t}_{i}^{UAV} ‖}^{2} ) . & \end{matrix}}}_{Geometric consistency constraint}$$
wherein
$$θ = \{ {K}_{UAV} , {K}_{UGV} , {\{ {R}_{i}^{UAV} , {t}_{i}^{UAV} \}}_{i = 1}^{{N}_{UAV}} , {\{ {R}_{k}^{UGV} , {t}_{k}^{UGV} \}}_{k = 1}^{{N}_{UGV}} , {\{ {X}_{j} \}}_{j = 1}^{M} \}$$
represents optimized parameters; M represents a total number of three-dimensional points; K_{UAV} represents an intrinsic parameter matrix of the UAV camera; K_{UGV} represents an intrinsic parameter matrix of the UGV camera;
$${R}_{i}^{UAV}$$
represents a UAV camera rotation matrix corresponding to an i-th UAV image;
$${t}_{i}^{UAV}$$
represents a UAV camera translation vector corresponding to the i-th UAV image;
$${R}_{k}^{UGV}$$
represents a UGV camera rotation matrix corresponding to a k-th UGV image;
$${t}_{k}^{UGV}$$
represents a UGV camera translation vector corresponding to the k-th UGV image; N_{UAV} represents a number of UAV images/poses involved in optimization; Mᵢ represents a number of effective observation points in the i-th UAV image;
$${x}_{ij}^{UAV}$$
represents a pixel observation of a j-th point in the i-th UAV image; Xⱼ represents a position of a j-th three-dimensional point in a world coordinate system, and three-dimensional point coordinates are obtained from co-visual pixel points of a plurality of two-dimensional images; N_{UGV} represents a number of UGV images/poses involved in optimization; Mₖ represents a number of effective observation points in the k-th UGV image;
$${ϰ}_{k ℓ}^{UGV}$$
represents a pixel observation of an l-th point in the k-th UGV image; [symbol] represents a position of an [symbol] -th three-dimensional point in the world coordinate system; λ₁, λ₂, and λ₃ represent weights of a point correspondence constraint, a scale constraint, and a geometric consistency constraint, respectively; M_{c} represents a number of co-visual point correspondences between the two platforms;
$${X}_{c}^{U A V}$$
represents a pixel observation of a c-th point correspondence in a UAV image;
$${X}_{c}^{UGV}$$
represents a pixel observation of the c-th point correspondence in a UGV image; Xₐ represents a position of an a-th three-dimensional point in a distance prior; X_{b} represents a position of a b-th three-dimensional point in the distance prior; d_{ab} represents a known physical distance between point Xₐ and point X_{b}; (a,b)∈ [symbol] Rᵣₑₗ represents a represents an index set of point pairs having known physical distances; relative rotation between the two cameras; tᵣₑₗ represents a relative translation between the (i,k)∈ [symbol] represents a set of UAV/UGV pose pairs for the geometric consistency two cameras; constraint; and π represents a camera projection function.

2. The method for three-dimensional reconstruction of traffic accident scenes combining ground and aerial perspectives according to claim 1, wherein the semantic segmentation of the images is performed using a segmentation network with a Segment Anything Model (SAM) architecture.

3. The method for three-dimensional reconstruction of traffic accident scenes combining ground and aerial perspectives according to claim 1, wherein the intrinsic parameter matrix of the UAV camera is K_{UAV} and the intrinsic parameter matrix of the UGV camera is K_{UGV} with expressions as follows:
$$\begin{matrix}{K}_{UAV} = [ \begin{matrix}{f}_{x}^{UAV} & 0 & {c}_{x}^{U A V} \\ 0 & {f}_{y}^{UAV} & {c}_{J}^{U A V} \\ 0 & 0 & 1\end{matrix} ] \\ {K}_{U G V} = [ \begin{matrix}{f}_{x}^{UGV} & 0 & {c}_{x}^{UGV} \\ 0 & {f}_{y}^{UGV} & {c}_{y}^{U G V} \\ 0 & 0 & 1\end{matrix} ]\end{matrix}$$
wherein
$${f}_{x}^{UAV}$$
represents an x-axis value of an equivalent focal length of the UAV camera in pixel coordinates;
$${f}_{y}^{UAV}$$
represents a y-axis value of an equivalent focal length of the UAV camera in pixel coordinates;
$${c}_{x}^{UAV}$$
represents an x-axis value of an imaging center of the UAV camera;
$${c}_{y}^{UAV}$$
represents a y-axis value of the imaging center of the UAV camera;
$${f}_{x}^{UGV}$$
represents an x-axis value of an equivalent focal length of the UGV camera in pixel coordinates;
$${f}_{y}^{UGV}$$
represents a y-axis value of the equivalent focal length of the UGV camera in pixel coordinates;
$${c}_{x}^{UGV}$$
represents an x-axis value of an imaging center of the UGV camera; and
$${c}_{y}^{UGV}$$
represents a y-axis value of the imaging center of the UGV camera.

4. The method for three-dimensional reconstruction of traffic accident scenes combining ground and aerial perspectives according to claim 1, wherein a method for the absolute scale recovery is as follows:
conducting distance measurement by using a depth camera carried on the UGV; arranging a calibration board of known dimensions within a visible range of the UAV; and establishing a scale ratio relationship:
$${S}_{a b s o l u t e} = \frac{{D}_{real}}{{D}_{r econstructed}} = \frac{‖ {P}_{1}^{real} - {P}_{2}^{r e a l} ‖}{‖ {P}_{1}^{r e c o n} - {P}_{2}^{recon} ‖}$$
wherein S_{absolute} represents a scale ratio for scaling a reconstructed model from reconstruction units to real meters; Dᵣₑₐₗ represents a real distance measured by the depth camera; D_{reconstructed} represents a relative distance in the reconstructed model;
$${P}_{1}^{real}$$
represents three-dimensional coordinates of a first point in real space;
$${P}_{2}^{real}$$
represents three-dimensional coordinates of a second point in real space;
$${P}_{1}^{recon}$$
represents three-dimensional coordinates in the reconstructed model corresponding to
$${P}_{1}^{real} ; and {P}_{2}^{recon}$$
represents three-dimensional coordinates in the reconstructed model corresponding to
$${P}_{2}^{real} .$$

5. A system for three-dimensional reconstruction of traffic accident scenes combining ground and aerial perspectives, comprising:
a semantic segmentation module configured to collect images of a traffic accident scene by using cameras mounted on two platforms, namely an unmanned aerial vehicle (UAV) camera and an unmanned ground vehicle (UGV) camera, perform semantic segmentation on the images, and generate pixel-level masks of key targets;
a region of interest (ROI) image acquisition module configured to extract ROIs from the images according to the pixel-level masks of the key targets, and perform image enhancement and denoising processing on the ROIs to obtain processed ROI images;
a three-dimensional reconstruction module configured to optimize intrinsic and extrinsic parameters of the UAV camera and the UGV camera, perform absolute scale recovery, and based on the pixel-level masks of the key targets and the processed ROI images, reconstruct a three-dimensional surface model by using a Structure-from-Motion (SfM) method incorporating a joint camera optimization objective function, a Multi-View Stereo (MVS) method, and a surface reconstruction method; and
an accident scene analysis module configured to perform digital quantitative analysis on the traffic accident scene through the three-dimensional surface model;
wherein a calculation formula of the joint camera optimization objective function is as follows:
$${E}_{total} ( θ ) = {\underbrace{{\sum }_{i = 1}^{{N}_{UAV}} {\sum }_{j = 1}^{{M}_{i}} {‖ {x}_{ij}^{UAV} - π ( {K}_{UAV} , {R}_{i}^{UAV} , {t}_{i}^{UAV} , {X}_{j} ) ‖}^{2}}}_{UAV pixel residual} + {\underbrace{{\sum }_{k = 1}^{{N}_{UGV}} {\sum }_{ℓ = 1}^{{M}_{k}} {‖ {x}_{k ℓ}^{UGV} - π ( {K}_{UGV} , {R}_{k}^{UGV} , {t}_{k}^{UGV} , {X}_{ℓ} ) ‖}^{2}}}_{UGV pixel residual} + {λ}_{1} {\underbrace{{\sum }_{c = 1}^{{M}_{c}} {‖ {X}_{c}^{UAV} - {X}_{c}^{UGV} ‖}^{2}}}_{Point correspondence constraint} + {λ}_{2} {\underbrace{{\sum }_{( a , b ) ∈ 𝒟} {( ‖ {X}_{a} - {X}_{b} ‖ - {d}_{ab} )}^{2}}}_{Scale constraint} + {λ}_{3} {\underbrace{{\sum }_{( l , k ) ∈ 𝒫} ( {‖ {R}_{k}^{UGV} {R}_{rel} - {R}_{i}^{UAV} ‖}_{F}^{2} + {‖ {t}_{k}^{UGV} + {R}_{k}^{UGV} {t}_{rel} - {t}_{l}^{UAV} ‖}^{2} )}}_{Geometric consistency constraint} .$$
wherein
$$θ = \{ {K}_{UAV} , {K}_{UGV} , {\{ {R}_{i}^{UAV} , {t}_{i}^{UAV} \}}_{i = 1}^{{N}_{UAV}} , {\{ {R}_{k}^{UGV} , {t}_{k}^{UGV} \}}_{k = 1}^{{N}_{UGV}} , {\{ {X}_{j} \}}_{j = 1}^{M} \}$$
represents optimized parameters; M represents a total number of three-dimensional points;
K_{UAV} represents an intrinsic parameter matrix of the UAV camera; K_{UGV} represents an intrinsic parameter matrix of the UGV camera;
$${R}_{i}^{UAV}$$
represents a UAV camera rotation matrix corresponding to an i-th UAV image;
$${t}_{i}^{UAV}$$
represents a UAV camera translation vector corresponding to the i-th UAV image;
$${R}_{k}^{UGV}$$
represents a UGV camera rotation matrix corresponding to a k-th UGV image;
$${t}_{k}^{UGV}$$
represents a UGV camera translation vector corresponding to the k-th UGV image; N_{UAV} represents a number of UAV images/poses involved in optimization; Mᵢ represents a number of effective observation points in the i-th UAV image;
$${x}_{ij}^{UAV}$$
represents a pixel observation of a j-th point in the i-th UAV image; Xⱼ represents a position of a j-th three-dimensional point in a world coordinate system, and three-dimensional point coordinates are obtained from co-visual pixel points of a plurality of two-dimensional images; N_{UGV} represents a number of UGV images/poses involved in optimization; Mₖ represents a number of effective observation points in the k-th UGV image;
$${x}_{k ℓ}^{UGV}$$
represents a pixel observation of an [symbol] -th point in the k-th UGV image; [symbol] represents a position of an e-th three-dimensional point in the world coordinate system; λ₁, λ₂, and λ₃ represent weights of a point correspondence constraint, a scale constraint, and a geometric consistency constraint, respectively; M_{c} represents a number of co-visual point correspondences between the two platforms; K_{UAV} represents a pixel observation of a c-th point correspondence in a UAV image;
$${x}_{c}^{UGV}$$
represents a pixel observation of the c-th point correspondence in a UGV image; Xₐ represents a position of an a-th three-dimensional point in a distance prior; X_{b} represents a position of a b-th three-dimensional point in the distance prior; d_{ab} represents a known physical distance between point Xₐ and point X_{b}; (a,b)∈ [symbol] Rᵣₑₗ represents a represents an index set of point pairs having known physical distances; relative rotation between the two cameras; tᵣₑₗ represents a relative translation between the (i,k)∈ [symbol] represents a set of UAV/UGV pose pairs for the geometric consistency two cameras; constraint; and π represents a camera projection function.

6. A non-transitory computer-readable storage medium, storing a computer program, wherein when executed by a processor, the computer program implements the method according to claim 1.

7. An electronic device, comprising a processor and a memory, wherein the processor and the memory are connected to each other, the memory is configured to store a computer program that comprises a computer-readable instruction, and the processor is configured to invoke the computer-readable instruction to execute the method according to claim 1.

8. A computer program product, comprising a computer program/instruction, wherein when executed by a processor, the computer program/instruction implements steps of the method according to claim 1.
